(19) United States
(12) Patent Application Publication
(10) Pub. No.: US 2021/0366011 A1
(43) Pub. Date: Nov. 25, 2021

(54) INFORMATION PROCESSING METHOD, INFORMATION PROCESSING APPARATUS, RECORDING MEDIUM, AND INFORMATION PROCESSING TERMINAL

(71) Applicant: Mercari, Inc., Tokyo (JP)

(72) Inventors: Keisuke SOGAWA, Tokyo (JP); Yasuyuki MATSUOKA, Tokyo (JP); Mayumi NUMASAKI, Tokyo (JP); Koji NOHARA, Tokyo (JP); Hiroki SAGIUCHI, Tokyo (JP); Motonori IWATA, Tokyo (JP)

(21) Appl. No.: 17/322,701

(22) Filed: May 17, 2021

(30) Foreign Application Priority Data
May 22, 2020 (JP) 2020-089515

(51) Int. Cl. G06Q 30/06

(52) U.S. Cl. CPC G06Q 30/0611; G06Q 30/0643; G06Q 30/0639

(57) ABSTRACT

An information processing method is executed by an information processing apparatus, and the information processing method includes listing, on a trading service, a first product designated by a first user, and upon receiving from a terminal of the first user an offer to barter the first product in exchange for a second product listed on the trading service by a second user, transmitting information indicating a shipment destination of the first product to the terminal of the first user, and transmitting information indicating a shipment destination of the second product to a terminal of the second user.

### CROSS-REFERENCE TO RELATED APPLICATION

The present application is based on and claims priority under 35 U. S. C. § 119 to Japanese Patent Application No. 2020-089515, filed on May 22, 2020, the content of which is incorporated herein by reference in its entirety.

### BACKGROUND OF THE INVENTION

The present disclosure relates to an information processing method, an information processing apparatus, a recording medium, and an information processing terminal.

### DESCRIPTION OF THE RELATED ART

In recent years, electronic commerce including flea market services and online auction services has become widespread. Also, conventionally, techniques for bartering products between users are known (see, for example, Japanese Patent Application Laid-Open No. 2003-044700).

### SUMMARY OF THE INVENTION

However, in the conventional techniques, for example, there is a problem in that it may be impossible to properly distribute products. It is an object of the present disclosure to provide a technique for properly distributing products.

An information processing method according to an embodiment of the present disclosure is executed by an information processing apparatus, and the information processing method includes listing, on a trading service, a first product designated by a first user, and upon receiving from a terminal of the first user an offer to barter the first product in exchange for a second product listed on the trading service by a second user, transmitting information indicating a shipment destination of the first product to the terminal of the first user, and transmitting information indicating a shipment destination of the second product to a terminal of the second user.

### BRIEF DESCRIPTION OF THE DRAWINGS

FIG. 1 is a drawing illustrating a configuration of a communication system according to an embodiment of the present disclosure;

FIG. 2 is a drawing illustrating an example of a hardware configuration of an information processing apparatus according to the embodiment;

FIG. 3 is a drawing illustrating an example of a block diagram illustrating a configuration of servers and terminals according to the embodiment;

FIG. 4 is a drawing illustrating an example of a sequence of processing of a communication system according to the embodiment;

FIG. 5A is a drawing illustrating an example of product information stored in a user information storage unit according to the embodiment;

FIG. 5B is a drawing illustrating an example of buying and selling information stored in a buying and selling information storage unit according to the embodiment;

FIG. 6A is a drawing for explaining an example of a display screen of a terminal according to the embodiment; and

FIG. 6B is a drawing for explaining an example of a display screen of a terminal according to the embodiment.

### DESCRIPTION OF THE EMBODIMENT

The disclosure set forth in this specification will be performed, if implemented, in compliance with the laws and regulations in each country in which the technique of the present disclosure is implemented. In addition, the disclosure set forth in this specification is implemented upon applying all changes, substitutions, variations, alterations, and modifications that can be made by those skilled in the art that are needed to comply with the laws and regulations in the country.

An embodiment for carrying out processing for providing bartering services according to the present disclosure is explained with reference to drawings.

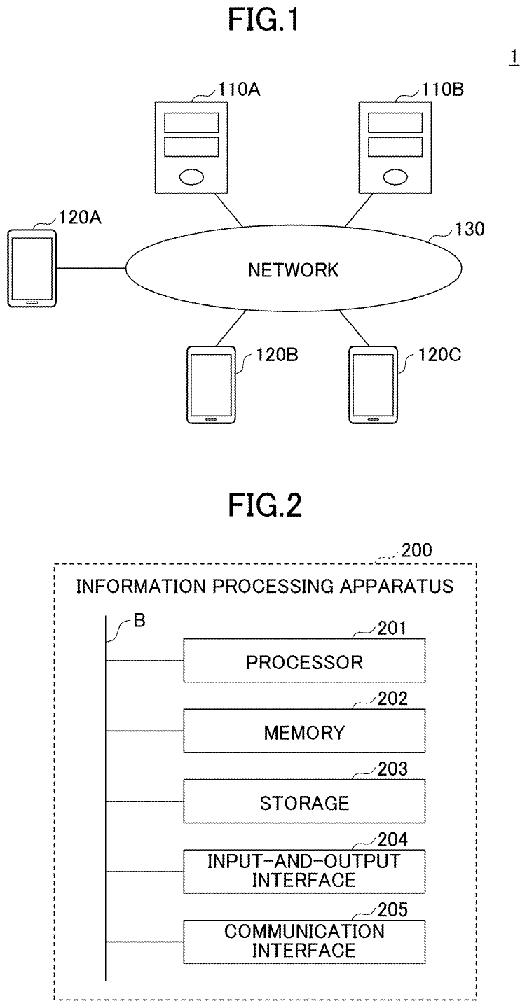

FIG. 1 is a drawing illustrating a configuration of a communication system 1 according to an embodiment of the present disclosure. As disclosed in FIG. 1, the communication system 1 is configured such that a server 110A, a server 110B, a terminal 120A, a terminal 120B, a terminal 120C, and the like are connected via a network 130.

In the present disclosure, in a case where it is not necessary to distinguish the server 110A and the server 110B from each other, each of the server 110A and the server 110B may be referred to as a server 110. The server 110 is an example of an “information processing apparatus”.

In the present disclosure, in a case where it is not necessary to distinguish the terminal 120A, the terminal 120B, and the terminal 120C from each other, each of the terminal 120A, the terminal 120B, and the terminal 120C may be referred to as a terminal 120 (an example of an “information processing terminal”). The numbers of servers 110 and terminals 120 are not limited to those shown in the example of FIG. 1.

In the present disclosure, in a case where it is not necessary to distinguish the server 110 and the terminal 120 from each other, each of the server 110 and the terminal 120 may be referred to as an information processing apparatus 200. The number of information processing apparatuses 200 connected to the network 130 is not limited to the example of FIG. 1.

The server 110 provides a predetermined service to the terminal 120 used by a user via the network 130. The predetermined service may include, but is not limited to, payment services, financial services, e-commerce services, bartering services, social media and social networking services (collectively referred to as “SNS”) such as messaging services using instant messengers, content provider services providing contents such as music, moving pictures, books (including comics and the like), and the like. For example, the payment services may include payment services using two-dimensional codes, near-field communication, and the like. In addition, the payment services may include deferred payment services by credit (loan). Also, the predetermined services may be provided by servers 110 independently provided for corresponding services.

The e-commerce services (trading services) may include, for example, consumer-to-consumer trading services such as online shopping services, online flea market services, online auction services, and may also include online pawnbroking (pawnshop) services. By allowing users to use the predetermined service with the terminals 120, the server 110 can provide the predetermined service to one or more terminals 120.

For example, the terminal 120 is a terminal such as a smartphone, a tablet, a personal computer, and the like used by a user, and performs processing for using various services provided by the server 110.

As necessary, the terminal used by a user X is referred to as a terminal 120X, and in the predetermined service, user information associated with the user X or the terminal 120X is referred to as user information X. The user information is information about a user associated with an account used by the user in the predetermined service. The user information may include, but is not limited to, the name of the user entered by the user or given by the predetermined service; information associated with the user such as an icon image of the user, the age of the user, the gender of the user, the address of the user, hobbies of the user, an identifier of the user, and the like; balance information of a digital currency (electronic money) associated with the user; and credit card information (such as credit card number) associated with the user. The user information may be any one of the above or a combination thereof.

The network 130 is configured to connect two or more information processing apparatuses 200. The network 130 refers to a communication network that provides a connection path allowing data to be transmitted and received after the terminal 120 connects to the server 110.

One or more portions of the network 130 may be a wired network or a wireless network. The network 130 includes, but is not limited to, Ad Hoc network, intranet, extranet, virtual private network (VPN), local area network (LAN), wireless LAN (WLAN), wide area network (WAN), wireless WAN (WWAN), metropolitan area network (MAN), a part of the Internet, a part of public switched telephone network (PSTN), cellular phone network, ISDNs (Integrated Service Digital Networks), wireless LAN, LTE (Long Term Evolution), CDMA (Code Division Multiple Access), Bluetooth (registered trademark), satellite communication, and the like, or a combination of two or more of the above. The network 130 may include one or more networks 130.

The information processing apparatus 200 may be any information processing apparatus as long as it is an information processing apparatus that can achieve functions and methods described in the present disclosure.

The information processing apparatus 200 includes, but is not limited to, a smartphone, a mobile phone (e.g., a feature phone), a computer (including, but not limited to, a desktop computer, a laptop computer, a tablet, and the like), a server apparatus, a media computer platform (including, but not limited to, a cable or satellite set-top box, a digital video recorder, and the like), a handheld computer device (including, but not limited to, a personal digital assistant (PDA), an e-mail client, and the like), a wearable terminal (including, but not limited to, a glasses-type device, a clock-type device, and the like), other types of computers, communication platforms, or the like.

A hardware configuration of the information processing apparatus 200 included in the communication system 1 will be explained with reference to FIG. 2. FIG. 2 is a drawing illustrating an example of a hardware configuration of the information processing apparatus 200 according to the embodiment.

The information processing apparatus 200 includes a processor 201, a memory 202, a storage 203, an input-and-output interface 204, and a communication interface 205. Constituent elements of hardware of the information processing apparatus 200 are connected by, for example, a bus B, but there is no limitation.

The information processing apparatus 200 achieves at least one of processes, functions, and methods described in the present disclosure by performing operations in cooperation with the processor 201, the memory 202, the storage 203, the input-and-output interface 204, and the communication interface 205.

The processor 201 executes the processes, functions, and methods implemented by codes or instructions included in a program stored in the storage 203. The processor 201 includes, but is not limited to, a central processing unit (CPU), a micro processing unit (MPU), a graphics processing unit (GPU), a microprocessor, a processor core, a multiprocessor, an application-specific integrated Circuit (ASIC), a field programmable gate array (FPGA), and the like, and each processing disclosed in each embodiment may be implemented by a logic circuit (hardware) or a dedicated circuit formed in an integrated circuit (e.g., an integrated circuit (IC) chip and a large-scale integration (LSI)) or the like. In addition, these circuits may be implemented by one or a plurality of integrated circuits, and a plurality of sets of processing described in each embodiment may be implemented by a single integrated circuit. The LSI is sometimes referred to as a VLSI, a super LSI, an ultra LSI, and the like, depending on the degree of integration.

The memory 202 temporarily stores a program loaded from the storage 203 and provides the processor 201 with a work area. The memory 202 also temporarily stores various data generated while the processor 201 is executing the program. The memory 202 includes, but is not limited to, a random access memory (RAM), a read-only memory (ROM), and the like.

The storage 203 stores programs. The storage 203 includes, but is not limited to, a hard disk drive (HDD), a solid state drive (SSD), a flash memory, and the like.

The communication interface 205 transmits and receives various data via the network 130. The communication may be performed via a wire or wirelessly, and any communication protocol may be used as long as mutual communication can be performed. The communication interface 205 has a function of executing communication with another information processing apparatus via the network 130. The communication interface 205 transmits various data to another information processing apparatus according to the instructions from the processor 201. Further, the communication interface 205 receives various data transmitted from another information processing apparatus and transmits the data to the processor 201.

The input-and-output interface 204 includes an input device that inputs various operations to the information processing apparatus 200, and an output device that outputs a processing result processed by the information processing apparatus 200. In the input-and-output interface 204, the input device and the output device may be integrated, or the input device and the output device may be separated.

The input device is implemented by one of or a combination of all kinds of devices capable of receiving an input from a user and transmitting information about the input to the processor 201. The input device includes, but is not limited to, a touch panel, a touch display, hardware keys such as a keyboard, a pointing device such as a mouse, a camera (i.e., an operation input by an image), and a microphone (i.e., an operation input by voice).

The output device is implemented by one of or a combination of all kinds of devices capable of outputting a processing result processed by the processor 201. In a case where the processing result is output as a video or a motion picture, the output device is implemented by one of or a combination of all kinds of devices capable of displaying a display image in accordance with the display data written to the frame buffer. The output device includes, but is not limited to, a touch panel, a touch display, a monitor (including, but not limited to, a liquid crystal display, an organic electroluminescence display (OLED), and the like), a head mounted display (HMD), a device capable of displaying an image, text information, and the like with projection mapping or hologram or in the air (alternatively, in vacuum), a speaker (i.e., audio output), a printer, and the like. It should be noted that the output device may be capable of displaying three-dimensional (3D) display data.

A program of each embodiment of the present disclosure may be provided in such a state that the program is stored in a computer-readable storage medium. The storage medium can store the program as a “non-transitory tangible medium”. The program includes, but is not limited to, a software program and a computer program.

The recording medium includes, where appropriate, one or more semiconductor-based or other integrated circuits (ICs) (including, but not limited to, a field programmable gate array (FPGA), an application specific integrated circuit (ASIC), and the like), a hard disk drive (HDD), a hybrid hard drive (hybrid HDD), an optical disk, an optical disk drive (ODD), a magneto-optical disk, a magneto-optical drive, a floppy diskette, a floppy disk drive (FDD), a magnetic tape, a solid state drive (SSD), a RAM drive, a secure digital card or drive, and any other suitable storage media, or the recording medium may be an appropriate combination of two or more of the above. The storage medium may be either a volatile or non-volatile medium, or may be a combination of volatile and non-volatile media, where appropriate.

The program of the present disclosure may be provided to the information processing apparatus 200 via any transmission medium (e.g., a communication network, a broadcast wave, or the like) capable of transmitting the program.

Each embodiment of the present disclosure can also be implemented in the form of a data signal embedded in a carrier wave, in which the program is embodied by electronic transmission.

Programs of the present disclosure are implemented by using script languages such as JavaScript (registered trademark) and Python, C programming language, Go programming language, Swift, Kotlin, Java (registered trademark), and the like, but are not limited thereto.

At least a part of the processing in the information processing apparatus 200 may be implemented by cloud computing constituted by one or more computers.

At least a part of the processing performed by the information processing apparatus 200 may be performed by another information processing apparatus. In this case, at least a part of the processing of each unit implemented by the processor 201 may be configured to be performed by another information processing apparatus.

Unless explicitly stated, a determination in the embodiment of the present disclosure is not mandatory. That is, instead of making a determination, a predetermined processing may be performed when a determination condition is satisfied, or a predetermined processing may be performed when a determination condition is not satisfied.

The present disclosure includes any and all changes, substitutions, variations, alterations, or modifications of the embodiment which can be applied by a person skilled in the art to the embodiment and examples of the present disclosure. The appended claims include any and all changes, substitutions, variations, alterations, or modifications which can be applied by a person skilled in the art to the embodiment and examples of the present disclosure. The present disclosure includes any combination of one or more features of the embodiment and examples of the present disclosure and one or more features of another embodiment and examples of the present disclosure, which can be made by a person skilled in the art.

In addition, reference in the appended claims to an apparatus or a system or constituent elements of the apparatus or the system adapted to, arranged to, having capability to, configured to, available to, operable to, or capable of operating to implement a particular process, function, or method includes an apparatus, a system, or constituent elements, regardless of whether the function of the apparatus, the system, or the constituent elements is activated, turned on, or unlocked, as long as the apparatus, the system, or the constituent elements are adapted to, arranged to, having capability to, configured to, available to, operable to, or capable of operating to implement the particular process, function, or method.

Unless otherwise explicitly stated, in implementing any one of the embodiments or the examples of the present disclosure, it may be possible to obtain agreement from a user in advance or immediately before execution. The agreement to be obtained may be a comprehensive agreement or may be an agreement obtained on each occasion.

The embodiment according to the present disclosure is an embodiment for providing a bartering service. According to the embodiment, for example, the convenience of bartering can be improved. Also, for example, bartering is enabled in an appropriate manner, and as a result, there is an advantage in that the loads of the terminal 120A and the server 110 and the load of the network 130 between the terminal 120A and the server 110 can be alleviated.

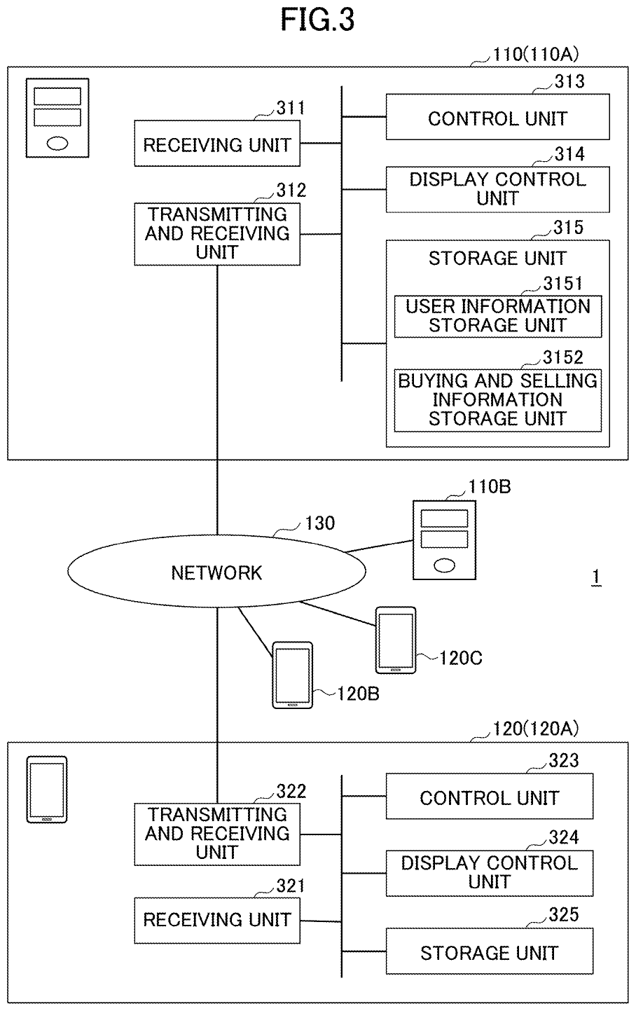

The configuration of the server 110 and the terminal 120 is explained with reference to FIG. 3. FIG. 3 is a drawing illustrating an example of a block diagram illustrating a configuration of the servers 110 and the terminals 120 according to the embodiment. The units disclosed in FIG. 3 are implemented by performing operations in cooperation with the processor 201, the memory 202, the storage 203, the input-and-output interface 204, and the communication interface 205 provided in the information processing apparatus 200.

The server 110 includes a receiving unit 311, a transmitting and receiving unit 312, a control unit 313, a display control unit 314, and a storage unit 315. The processing, function, or process performed by each functional unit may be implemented by machine learning or artificial intelligence (AI) to the extent that the processing, function, or process can be implemented.

The receiving unit 311 receives various setting operations from a company that operates various services provided by the server 110.

The transmitting and receiving unit 312 transmits and receives data to and from the terminal 120 according to an instruction of the control unit 313. For example, when a user of the terminal 120 and the like is authenticated with a user ID and a password included in a login request from the terminal 120 and the like, the transmitting and receiving unit 312 may establish a communication session using HTTPS and the like with the terminal 120 and the like. In association with an ID of the established communication session, the address for communication with the terminal 120 and the like, the user ID, and the like may be stored. By using the established communication session, data may be transmitted to the terminal 120 and the like.

The control unit 313 performs processing for providing various kinds of services such as e-commerce services, bartering services, payment services, and the like to the user of the terminal 120 via the network 130.

The display control unit 314 transmits information for controlling the display screen of the terminal 120 and the like to the transmitting and receiving unit 312 according to the instructions of the control unit 313.

The storage unit 315 includes a user information storage unit 3151 storing information about users, a buying and selling information storage unit 3152 storing buying and selling information, and the like.

The terminal 120 includes a receiving unit 321, a transmitting and receiving unit 322, a control unit 323, a display control unit 324, and a storage unit 325. The processing, function, or method performed by each functional unit may be implemented by machine learning or artificial intelligence (AI) to the extent that the processing, function, or method can be implemented.

The receiving unit 321 receives various kinds of operations and the like from the user of the terminal 120.

The transmitting and receiving unit 322 transmits and receives data to and from the server 110 according to an instruction of the control unit 323. For example, the transmitting and receiving unit 322 may establish a communication session using HTTPS or the like with the server 110 when the terminal 120 logs in to the server 110. The communication address and the like of the server 110 may be stored in association with the ID of the established communication session. Data may be transmitted to the server 110 using the established communication session.

The control unit 323 performs processing using various kinds of services provided by the server 110. The display control unit 324 controls the display screen of the terminal 120 on the basis of information and the like received from the server 110 according to instructions of the control unit 323. The storage unit 325 stores information for using services and the like provided by the server 110.

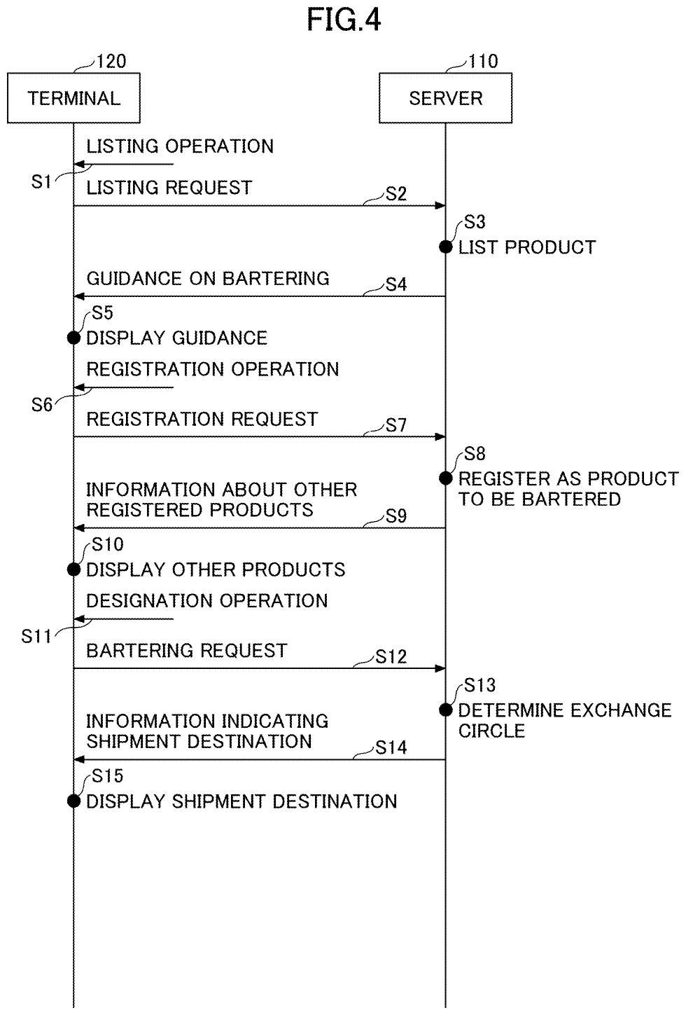

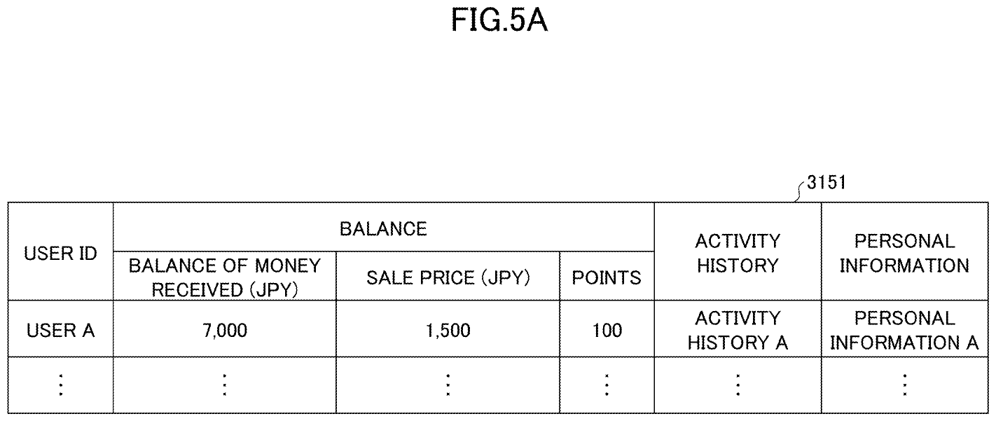

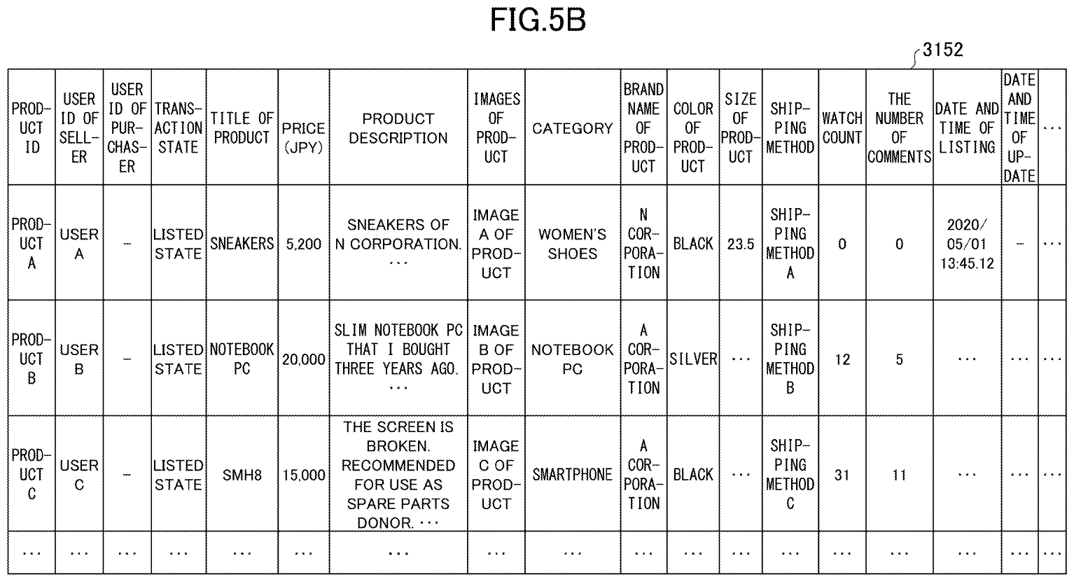

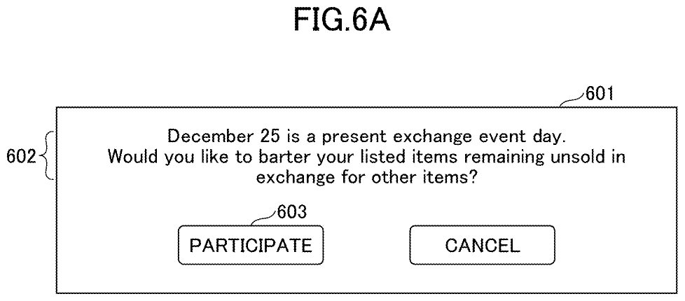

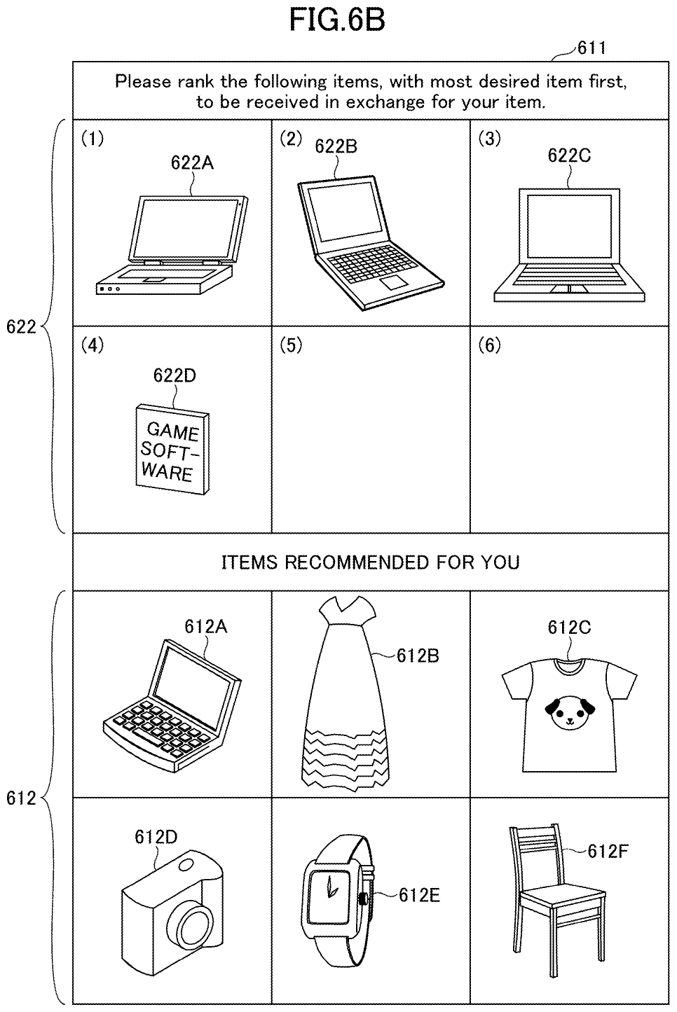

An example of processing performed by the communication system 1 according to the embodiment is explained with reference to FIG. 4 to FIG. 6B. FIG. 4 is a drawing illustrating an example of a sequence of the processing performed by the communication system 1 according to the embodiment. FIG. 5A is a drawing illustrating an example of user information stored in the user information storage unit 3151 according to the embodiment. FIG. 5B is a drawing illustrating an example of buying and selling information stored in the buying and selling information storage unit 3152 according to the embodiment. FIG. 6A and FIG. 6B are drawings for explaining examples of display screens displayed on the terminal 120 according to the embodiment.

Hereinafter, for example, an example in which the product B of the user B is delivered to the user A, the product A of the user A is delivered to the user C, and the product C of the user C is delivered to the user B is explained. In the disclosed technique, the number of users who participate in bartering is not limited to three, and the number of users who participate in bartering may be two or may be four or more.

In the following, processing performed on the terminal 120A of the user A is explained as an example, but similar processing may be performed on the terminal 120B of the user B and the terminal 120C of the user C. It is assumed that each terminal 120 has been authenticated by the server 110 using the account of the user when the terminal 120 communicates with the server 110.

In step S1, the terminal 120A receives from the user A an operation for listing a product A (an example of a “first product”) on a trading service. Herein, for example, the terminal 120A may receive an operation for inputting product information (a price, descriptions, images, and the like) about the product A.

Subsequently, the terminal 120A transmits a listing request to the server 110 (step S2). In this case, for example, the listing request may include information such as the user ID of the user A, the title of the product A entered in the processing of step S1, the price (in Japanese Yen), a product description, images of the product, a category, a brand, the color of the product, the size of the product, a shipping method, and the like.

Subsequently, the server 110 lists the product A on the trading service on the basis of the received listing request (step S3). This allows other users to purchase the product A from the user A on the trading service provided by the server 110.

In this case, as illustrated in FIG. 5A, the server 110 may cause the user information storage unit 3151 to store information about an activity history indicating that the user A has listed the product A.

In the example of FIG. 5A, the user information storage unit 3151 stores the balance, the activity history, and the personal information in association with the user ID. The user ID is identification information about the user.

The balance is a balance of a value that the user can use for various kinds of payments on the payment service provided by the server 110 or the servers connected to the server 110. In the example of FIG. 5A, the balance includes a balance of money received (Japanese Yen), a sale price (Japanese Yen), and reward points. The balance of money received is, for example, a balance of digital currency topped up at a bank, with a credit card, with a cash register in a store, or the like. The sale price is, for example, a total amount obtained by subtracting the selling fee from the price of a product when the user sells the product by using the trading service provided by the server 110.

The reward points are, for example, points given to the user from the server 110, and are, for example, points that can be used for a payment or a settlement of a deferred payment on the payment service provided by the server 110. It may be configured such that one point is treated equivalent to one Japanese Yen in payment. In the example of FIG. 5A, the balance of money received is 7000 Japanese Yen, the sale price is 1500 Japanese Yen, and the reward points are equivalent to 100 Japanese Yen. Therefore, the balance that the user A can use for payment is totally 8600 Japanese Yen. Although not illustrated, creditworthiness (a credit score) may be associated with the user ID.

The activity history is an activity history of the user. The activity history may include, for example, an activity history in the payment service provided by the server 110 and an activity history in the e-commerce service provided by the server 110. The activity history in the payment service may include, for example, a history of balance including a deposit and withdrawal history including payments made when products are purchased at stores, consumer-to-consumer remittances, top up of the balance from a bank account of a financial institution, and the like. The activity history in the payment service may include, for example, a deferred payment history including a payment history by the deferred payment, a settlement history of debts made by the deferred payment, and the like.

The activity history in the e-commerce service may include, for example, a history of listing of products, a history of selling (sales), a history of purchases, a search history of searches of listed products, which are performed by the user associated with the user ID, and may include, for example, a history of watches and comments on listed products.

The personal information is personal information about the user. The personal information may include, for example, information about the name, address, date of birth, annual income, family structure, whether the user owns a house, work place (occupation), and the like.

In this case, as illustrated in FIG. 5B, the server 110 may cause the buying and selling information storage unit 3152 to store information indicating that the product A is listed for selling by the user A.

In the example of FIG. 5B, the buying and selling information storage unit 3152 stores, in association with the product ID, the user ID of the seller, the user ID of the purchaser, transaction state, the title of the product, the price (Japanese Yen), product description, images of the product, category, brand, the color of the product, the size of the product, shipping method, a watch count, the number of comments, the date and time of listing, and the date and time of update, and the like.

The product ID is identification information of a product listed by the user. The transaction state is a state of a transaction of the product associated with the product ID. For example, the transaction state includes a “listed” state, an “in-transaction” state, a “transaction completed” state, a “listing removed” state, a state of “cancellation by the purchaser”, a state of “cancellation by the company providing the trading service”, a “listed (to be bartered)” state, an “in-bartering transaction” state, a “bartering completed” state, and the like. The “listed” state is a state in which any user can purchase the product associated with the product ID. The “in-transaction” state is a state from when the purchaser performs a purchase operation until a product shipped by the seller is delivered to the purchaser and the purchaser performs an operation for confirming reception. The “transaction completed” is a state after the purchaser performs an operation for confirming reception. The “listing removed” is a state in which the seller removed the listing. The “cancellation by the purchaser” is a state in which the purchaser cancelled purchase. The “cancellation by the company providing the trading service” is a state in which purchaser's purchasing of an illegal listed item and the like has been cancelled by the administrator of the server 110. The “listed (to be bartered)” is a state in which the user has listed the product to be bartered. Similarly with the product in the “listed” state, the server 110 may allow the product in the “listed (to be bartered)” state to be purchased by another user in the trading service. The “in-bartering transaction” state is a state from when the bartering is agreed upon until a product shipped by the seller is delivered to the shipment destination and the user of the shipment destination performs an operation for confirming reception. The “bartering completed” state is a state after the user of the shipment destination performs an operation for confirming reception.

The title of the product, the price (Japanese Yen), product description, images of the product, category, brand, the color of the product, the size of the product, and shipping method are the title of the product associated with the product ID, the selling price designated by the seller, product description, images of the product, category, brand name, color, size, and shipping method, respectively, configured by the user of the seller and the like. The number of watches and the number of comments are the number of times the product associated with the product ID is watched (liked, or added to favorites or bookmarks) by users of terminals 120 and the number of comments posted by the users, respectively. In a case where the user B watches the product A, the server 110 may record, in the activity history of the user B, information indicating that the product A is watched, and may allow transition from a watch list screen displayed on the terminal 120B of the user B to a screen of the product A. In a case where the price of the product A is reduced by the user A, the server 110 may transmit, to each of the users who are watching the product A, a notification indicating that the price of the product A is reduced.

In a case where the user B posts a comment on the product A, the server 110 may record, in the activity history of the user B, information indicating that a comment on the product A was posted, and may transmit, to the terminal 120A of the user A, information about the comment.

The date and time of listing is the date and time when the product associated with the product ID was listed for selling. The date and time of update is the date and time when various kinds of information about the product associated with the product ID recorded in the buying and selling information storage unit 3152 were updated.

When listing, selling, and the like are performed on the trading service provided by the server 110, the control unit 313 of the server 110 may cause the buying and selling information storage unit 3152 to store information about listing, selling, and the like.

Subsequently, the server 110 may transmit a guidance for bartering the product A to the terminal 120A (step S4). In this case, for example, in a case where the product A satisfies a predetermined condition, the server 110 may transmit, to the terminal 120A, information for displaying a display screen for suggesting to barter the product A in exchange for a product listed on the trading service by another user. Therefore, for example, it is possible to suggest to the user to barter unsold products and barter products expected to remain unsold. Also, it is to be understood that the server 110 may receive a request from the user A to adopt the product A as a product to be bartered.

For example, in a case where a period of time elapsed since the product A was listed on the trading service satisfies a predetermined condition, the server 110 may transmit the guidance to that effect. In this case, for example, in a case where a period of time the product A remained unsold (not purchased by another user) since the product A had been listed is equal to or more than a threshold value according to the category of the product A (for example, 30 days in the category of women's shoes), the server 110 may transmit the guidance to that effect. In this case, the server 110 may determine the threshold value on the basis of, for example, a representative value (for example, a mean value, a median value, a most frequent value, and the like) of a period of time from when a product in a certain category had been listed until the product was purchased.

Also, for example, in a case where the number of times the user A reduced the price of the product A listed on the trading service satisfies a predetermined condition, the server 110 may transmit the guidance to that effect. In this case, for example, in a case where the number of times the price of the product A is reduced is equal to or more than a threshold value (for example, 5 times), the server 110 may transmit the guidance to that effect. Therefore, for example, it is possible to suggest to the user to barter the product A that remains unsold even if its price has been reduced many times.

For example, in a case where the number of times other users perform a registration operation for registering watches, comments, and the like for the product A on the trading service satisfies a predetermined condition, the server 110 may transmit the guidance to that effect. In this case, for example, in a case where the number of users who watched the product A is equal to or more than a threshold value (for example, 10), the server 110 may transmit the guidance to that effect. Accordingly, for example, in a case where there are many users who register watching of the product A in order to receive a notification of price reduction without purchasing the product A because the price that is set by the user A is high, it is possible to suggest to the user A to barter the product A. For example, in a case where the number of comments for the product A is equal to or more than a threshold value (for example, 10), the server 110 may transmit the guidance to that effect. Accordingly, for example, in a case where there are many comments of negotiation for price reduction because the price that is set by the user A is high, it is possible to suggest to the user A to barter the product A.

For example, in a case where the price that is set by the user A for the product A and a price at which a product, of which the similarity with the product A is equal to or more than a threshold value, is sold satisfy a predetermined condition, the server 110 may transmit the guidance to that effect. In this case, for example, in a case where a value of a ratio of the price that is set by the user A for the product A to a representative value of prices at which products similar to the product A (for example, the same product as the product A, a product of which the size or the color is different from the product A, and the like) are sold is equal to or more than a threshold value (for example, 1.2), the server 110 may transmit the guidance to that effect. Accordingly, for example, in a case where the product A is expected to remain unsold because the price that is set by the user A is higher than the market price (the price at which it is actually sold in the market), it is possible to suggest to the user A to barter the product A.

For example, in a case where a representative value of periods of times from when products of which the similarities with the product A are equal to or more than a threshold value are listed until they are sold satisfies a predetermined condition, the server 110 may transmit the guidance to that effect. In this case, for example, in a case where a representative value of periods of times from when the same product as the product A, a product of which the size or the color is different from the product A, and the like are listed until they are sold is equal to or more than a threshold value (for example, 30 days), the server 110 may transmit the guidance to that effect. Accordingly, for example, in a case where it is expected that it takes a long time to sell the product A, it is possible to suggest to the user A to barter the product A.

Also, for example, in a case where the number of products of which the similarities with the product A are equal to or more than a threshold value from among the products listed on the trading service satisfies a predetermined condition, the server 110 may transmit the guidance to that effect. In this case, for example, in a case where the number of the same products as the product A, the number of products of which the sizes or the colors are different from the product A, and the like, which are listed unsold (i.e., the number of products in stock), is equal to or more than a threshold value (for example, 10), the server 110 may transmit the guidance to that effect. Accordingly, for example, in a case where the product A is expected to remain unsold, it is possible to suggest to the user to barter the product A.

(Offering of Coupons)

The server 110 may give a reward to the user A for bartering the product A. In this case, for example, in the processing of step S4, the server 110 may notify the user A by transmitting to the terminal 120A information for explaining the reward. The offering of the reward is explained later.

Subsequently, the terminal 120A displays the received guidance on a screen (step S5). In the example of FIG. 6A, the terminal 120A displays a message 602 for prompting bartering of the product and a “participate” button 603 on the display screen 601.

Subsequently, the terminal 120A receives, from the user A, an operation for registering the product A on the bartering service (step S6). In this case, the terminal 120A may receive a press-down operation of a “participate” button 603 of FIG. 6A.

Subsequently, the terminal 120A transmits a registration request to the server 110 (step S7). In this case, for example, the registration request may include information about the product ID of the product A and the like.

Subsequently, the server 110 registers the product A on the bartering service on the basis of the received registration request (step S8). In this case, the server 110 may update the transaction state of the product A from the “listed” state to the “listed (to be bartered)” state in the buying and selling information stored in the buying and selling information storage unit 3152.

Subsequently, the server 110 transmits information about another product registered in the bartering service to the terminal 120A (step S9). In this case, for example, the server 110 may select a product to be recommended to the user A from among other products registered in the bartering service, and may display information about the selected product on the terminal 120A. In this case, for example, the server 110 may select, as a candidate of a product in exchange for which the product A is bartered, a product according to personal information (attribute) about the user A, the activity history in the trading service by the user A, or the activity history in the payment service by the user A stored in the user information storage unit 3151, or according to two or more thereof. For example, a product that belongs to the same category as a category in which the user A purchased many products on the trading service or a category in which the user A purchased many products with the payment service may be selected as a candidate of a product in exchange for which the product A is bartered, but the embodiment is not limited thereto.

Also, the server 110 may display, on the terminal 120A, information about products in exchange for which the product A can be bartered. In this case, for example, the server 110 may display, as products in exchange for which the product A can be bartered, the product C of the user C who is offering to barter the product C in exchange for the product A and the product B of the user B who is offering to barter the product B in exchange for the product C. Then, in a case where the user A chooses the product C, the server 110 may allow the products A and the product C to be bartered between the user A and the user C. In a case where the user A chooses the product B, the server 110 may allow the user A to obtain the product B, allow the user B to obtain the product C, and allow the user C to obtain the product A.

The server 110 may subtract, from the balance of the user A, a selling fee according to the number of products registered on the bartering service displayed on the terminal 120A.

Subsequently, the terminal 120A displays, on the screen, information about the received other products (step S10). Subsequently, the terminal 120A receives, from the user A, an operation for designating a product in exchange for which the product A is to be given (applied or offered to be bartered) (step S11).

In the example of FIG. 6B, the terminal 120A displays, in an area 612 on the display screen 611, other products 612A to 612F registered on the bartering service. In response to the user A's operation, the terminal 120A sets and displays, in the area 622, the products 622A to 622D in exchange for which the product A is to be bartered, in the order desired by the user A.

Also, the terminal 120A may display information about the received other products one by one, and may receive, for example, an operation of right flick in a case where the user A wishes bartering and an operation of left flick in a case where the user A does not wish bartering. In response to an operation for selecting a product in exchange for which the user A wishes bartering the product A, the terminal 120 or the server 110 may store the user A's interests and tastes as the user A's activity history in the e-commerce service. Also, in accordance with an increase in the user A's operation intensity (operation speed, operation time, and operation pressure), it may be determined that the user A is more greatly interested.

The server 110 may receive a handling fee from the user A, and may cause the terminal 120A to display, with respect to a product in exchange for which the user A wishes to barter the product A, information as to which user offers to barter a product in exchange for what kind of product.

Subsequently, the terminal 120A transmits a bartering request (an offer for bartering) to the server 110 (step S12). The bartering request may include, for example, information about the user ID of the user A, the order of products and product IDs designated by the user A, and the like.

In this case, the server 110 may subtract (charge), from the balance of the user A, a price, as a handling fee and the like, according to the number of products (the number of product IDs) designated by the user A as a product in exchange for which the user A wishes to barter the product A. In this case, for example, in accordance with an increase in the number of designated products in exchange for which the product A is wished to be bartered, the server 110 may increase the unit price of the handling fee.

In this case, for example, in a case where the number of products (product IDs) designated as a product in exchange for which the user A offers to barter the product A is a first number (for example, 5), the server 110 subtracts, from the balance of the user A, a price (for example, 250 Japanese Yen (=50 Japanese Yen×5)) according to a first unit price (for example, 50 Japanese Yen), and in a case where the number of products (product IDs) designated as a product is a second number (for example, 10) that is larger than the first number, the server 110 subtracts, from the balance of the user A, a price (for example, 1000 Japanese Yen (=100 Japanese Yen×10)) according to a second unit price (for example, 100 Japanese Yen) that is larger than the first unit price. Therefore, for example, this can inhibit the user A from offering to barter the product A in exchange for many possible products in an attempt to successfully barter the product A, of which value is low, in exchange for a certain product. Accordingly, for example, this can inhibit a non-useful offer from being presented to many other users and can reduce the load of the processing for determining the exchange circle in the network where the bartering is operated in step S13 by the server 110.

Subsequently, the server 110 determines an exchange circle (a shipment destination of a product of each user) in the bartering service on the basis of the bartering request from each user (step S13). In this case, for example, the server 110 may determine that the user A obtains product B, the user C obtains product A, and the user B obtains product C. In this case, for example, the server 110 may use a top trading cycle (TTC) algorithm and the like to determine products obtained by the users through the bartering. Then, in the buying and selling information stored in the buying and selling information storage unit 3152, the server 110 may update the transaction states of the product A, the product B, and the product C from the “listed (to be bartered)” state to the “in-bartering transaction” state.

Subsequently, the server 110 transmits, to the terminal 120A of the user A, information indicating the shipment destination (the shipping destination) of the product A bartered by the user A on the basis of the determined exchange circle (step S14). In this case, the information indicating the shipment destination is not particularly limited so long as it is information that enables delivery (shipping). The information indicating the shipment destination may include, for example, information about the address of the user C that is the shipment destination. In a case where the user C that is the shipment destination uses an anonymous shipping service for hiding the name and address of the user C from the user who ships the product, the information indicating the shipment destination may include, for example, the user ID of the user C that is the shipment destination, information with which only the delivery company can identify the address, and the like. Likewise, the server 110 transmits, to the terminal 120B of the user B, information indicating the address and the like of the user A that is the shipment destination to which the product B, which the user B barters, is delivered. Likewise, the server 110 transmits, to the terminal 120C of the user C, information indicating the address and the like of the user B that is the shipment destination to which the product C, which the user C barters, is delivered.

Subsequently, the terminal 120A displays the information indicating the shipment destination on the screen (step S15). Accordingly, the user A can deliver the product A to the user C. The information indicating the shipment destination may include, for example, the information about the user C. Also, the information indicating the shipment destination may include, for example, a two-dimensional code and the like that is presented to the delivery company by the user A and that is associated with the information about the user C.

In a case where the product A is bartered, the server 110 may give a reward to the user A. In this case, for example, in a case where the server 110 receives, from the terminal 120C, information indicating that the user C that is the shipment destination to which the product A is delivered has confirmed reception and has left a feedback, the server 110 may give a reward to the user A. For example, the server 110 may add, as the reward given to the user A, reward points to the balance of the user A. In this case, for example, the server 110 may give reward points to the balance of the user A by providing a discount and the like of various kinds of handling fees in various kinds of services provided by the server 110.

For example, the server 110 may give the user A a reward according to a period of time elapsed since the product A was listed on the trading service. In this case, for example, in accordance with an increase in the period of time elapsed with the product A remaining unsold since the product A was listed for selling, the server 110 may give a larger reward (for example, more points, more discount coupons, and the like). Accordingly, for example, the user A can be appropriately motivated to barter the product A that has been remaining unsold for a long period of time.

For example, the server 110 may give the user A a reward according to the number of times the user A reduced the price of the product A. In this case, for example, in accordance with an increase in the number of times the user A reduced the price of the product A, the server 110 may give a larger reward. Accordingly, for example, the user A can be appropriately motivated to barter the product A that cannot be sold no matter how many times the price is reduced.

For example, the server 110 may give the user A a reward according to the number of times other users perform a predetermined registration operation with regard to the product A. In this case, for example, in accordance with an increase in a watch count and the number of comments on the product A, the server 110 may give a larger reward. Accordingly, for example, the user A can be appropriately motivated to barter the product A that is expected to be discounted by many users.

For example, the server 110 may give the user A a reward according to the price that is set by the user A for the product A and a price at which a product of which the similarity with the product A is equal to or more than a threshold value is sold. In this case, for example, in accordance with an increase in a ratio of the price that is set by the user A for the product A to a representative value of prices at which products similar to the product A are sold, the server 110 may give a larger reward. Accordingly, for example, the user A can be appropriately motivated to barter the product A that is expected to be highly likely to remain unsold.

For example, the server 110 may give the user A a reward according to a representative value of periods of times from when products of which the similarities with the product A are equal to or more than a threshold value are listed until they are sold. In this case, for example, in accordance with an increase in the representative value, the server 110 may give a larger reward. Accordingly, for example, the user A can be appropriately motivated to barter the product A which is expected to take a long time to sell.

A reward according to the number of products of which the similarities with the product A are equal to or more than a threshold value from among the products listed on the trading service may be given to the user A. In this case, for example, in accordance with an increase in the number of products that are the same as the product A, the number of products of which the sizes or the colors are different from the product A, and the like, which are listed and remain unsold, the server 110 may give a larger reward. Accordingly, for example, the user A can be appropriately motivated to barter the product A that is expected to remain unsold because a large number of products similar to the product A are in stock.

In a case where bartering of the product A is not agreed upon in the processing of step S13 of FIG. 4, the server 110 may cause the terminal 120A to display information about products which other users offer to barter in exchange for the product A. Accordingly, for example, the user A can ascertain that there are other users who wish to obtain the product A, and accordingly, the user A can be motivated to participate a subsequent bartering.

In a case where bartering of the product A is not agreed upon in the processing of step S13 of FIG. 4, the server 110 may cause the terminal 120A to display information about a product of another user in exchange for which the user B, who is the seller of the product B in exchange for which the user A is offering to barter the product A, is offering to barter the product B. Accordingly, for example, the user A can ascertain that the user B who is listing the product B, which the user A wishes to obtain, also wishes to actually barter the product B in exchange for another product, and accordingly, the user A can be motivated to participate in a subsequent bartering.

In a case where bartering of the product A is not agreed upon in the processing of step S13 of FIG. 4, the server 110 may give a user D a reward according to the product D listed by the user D, and may establish bartering among multiple users including the user A and the user D. In this case, the server 110 may cause a terminal 120D of the user D to display a message indicating that reward points according to the market price of the product D on the trading service are going to be given to the user D. Then, in a case where the user D performs an approval operation on the terminal 120D, the server 110 may establish bartering. Accordingly, for example, the bartering can be established with the cost borne by the company that operates the trading service on the server 110.

What is claimed is:

1. An information processing method executed by an information processing apparatus, the information processing method comprising:
listing, on a trading service, a first product designated by a first user; and
upon receiving from a terminal of the first user an offer to barter the first product in exchange for a second product listed on the trading service by a second user, transmitting information indicating a shipment destination of the first product to the terminal of the first user, and transmitting information indicating a shipment destination of the second product to a terminal of the second user.

2. The information processing method according to claim 1, further comprising:
transmitting, to the terminal of the first user, information for displaying a display screen for allowing the first user to input information for offering to barter the first product in exchange for a product listed on the trading service, in response to determining that a predetermined condition is satisfied by:
a period of time elapsed since the first product was listed on the trading service;
a number of times a price of the first product is reduced by the first user;
a number of times a predetermined registration operation is performed with respect to the first product by other users;
a price that is set by the first user for the first product;
a price at which a product of which similarity with the first product is equal to or more than a threshold value is sold;
a representative value of periods of time from when products of which similarities with the first product are equal to or more than a threshold value are listed to when the products are purchased; or
a number of products of which similarities with the first product are equal to or more than a threshold value from among products listed on the trading service.

3. The information processing method according to claim 1, further comprising:
transmitting, to the terminal of the first user, information for displaying, as a candidate of a product in exchange for which the first product is bartered, a product according to an attribute of the first user, an activity history of the first user on the trading service, and an activity history of the first user on a payment service, or according to two or more thereof.

4. The information processing method according to claim 1, further comprising:
transmitting, to the terminal of the first user, information for displaying, as products in exchange for which the first product can be bartered, a third product of a third user who is offering to barter the third product in exchange for the first product and the second product of the second user who is offering to barter the second product in exchange for the third product.

5. The information processing method according to claim 1, further comprising:
subtracting, from a balance of the first user, a price according to a number of products designated as a product in exchange for which the first user offers to barter the first product.

6. The information processing method according to claim 5, wherein the subtracting further comprises:
subtracting a price according to a first unit price from the balance of the first user, in a case where the number of products designated as a product in exchange for which the first user offers to barter the first product is a first number; and
subtracting a price according to a second unit price that is higher than the first unit price from the balance of the first user, in a case where the number of products designated as a product in exchange for which the first user offers to barter the first product is a second number that is larger than the first number.

7. The information processing method according to claim 1, further comprising:
in a case where the first product is bartered, adding, to the balance of the first user, a reward according to:
a period of time elapsed since the first product was listed on the trading service;
a number of times a price of the first product is reduced by the first user;
a number of times a predetermined registration operation is performed with respect to the first product by another user;
a price that is set by the first user for the first product;
a price at which a product of which similarity with the first product is equal to or more than a threshold value is sold;
a representative value of periods of time from when products of which similarities with the first product are equal to or more than a threshold value are listed to when the products are purchased; or
a number of products of which similarities with the first product are equal to or more than a threshold value from among products listed on the trading service.

8. The information processing method according to claim 1, further comprising:
in a case where bartering of the first product is not agreed upon, transmitting, to the terminal of the first user, information for displaying a product which a fourth user offers to barter in exchange for the first product and a product of a fifth user in exchange for which the second user offers to barter the second product.

9. The information processing method according to claim 1, further comprising:
in a case where bartering of the first product is not agreed upon, establishing a bartering between a plurality of users including the first user and a sixth user by giving the sixth user a reward according to a product listed by the sixth user.

10. An information processing apparatus comprising:
a processor configured to perform the information processing method of claim 1.

11. A non-transitory computer-readable recording medium storing a program executable by a processor of an information processing apparatus, wherein the program causes the processor to perform the information processing method of claim 1.

12. An information processing method executed by an information processing terminal, the information processing method comprising:
transmitting, to an information processing apparatus, a request for listing a first product on a trading service provided by the information processing apparatus, in response to an operation performed by a first user;
transmitting, to the information processing apparatus, an offer of bartering the first product in exchange for a second product listed on the trading service by a second user, in response to an operation performed by the first user; and
receiving, from the information processing apparatus, information indicating the shipment destination of the first product.

13. An information processing terminal comprising a processor configured to perform the information processing method of claim 12.

14. A non-transitory computer-readable recording medium storing a program executable by a processor of an information processing terminal, wherein the program causes the processor to perform the information processing method of claim 12.
